(19) United States
(12) Patent Application Publication
(10) Pub. No.: US 2015/0228225 A1
(43) Pub. Date: Aug. 13, 2015

(54) DISPLAY APPARATUS AND DISPLAY METHOD

(71) Applicant: Sony Corporation, Tokyo (JP)

(72) Inventor: Hidehisa Shimizu, Kanagawa (JP)

(21) Appl. No.: 14/608,270

(22) Filed: Jan. 29, 2015

(30) Foreign Application Priority Data
Feb. 13, 2014 (JP) 2014-025079

(51) Int. Cl. G09G 3/32

(52) U.S. Cl. CPC G09G 3/3233; G09G 3/3266; G09G 2300/0842; G09G 2320/0233

(57) ABSTRACT

A display apparatus includes light-emission units, write transistors, drive transistors, and a plurality of gate drivers. The light-emission units each form a pixel and each configured to emit light by a drive current. The write transistors are each configured to write a video signal of each pixel in each of pixel capacitances. The drive transistors are each configured to control the drive current of the light-emission unit by a voltage corresponding to the video signal written in the pixel capacitance. The plurality of gate drivers are configured to control write of the video signal in the pixel capacitances by the write transistors and control a drive voltage supplied to the drive transistors, the plurality of gate drivers being each configured to perform control such that the write transistors write the video signal in the pixel capacitances of all the pixels and then supply the drive voltage to the drive transistors.

### CROSS REFERENCE TO RELATED APPLICATIONS

This application claims the benefit of Japanese Priority Patent Application JP 2014-025079 filed Feb. 13, 2014, the entire contents of which are incorporated herein by reference.

### BACKGROUND

The present disclosure relates to a display apparatus and a display method, and more particularly, to a display apparatus and a display method by which the degree of freedom in wiring design is enhanced.

Recently, in the fields of display apparatuses performing image display, a display apparatus (organic EL display apparatus) including a light-emitting element has been developed and commercialized (see, for example, Japanese Patent Application Laid-open No. 2009-244665). Specifically, the light-emitting element is a current-driven-type optical element with light emission luminance that changes in accordance with a value of a flowing current, such as an organic EL (Electro Luminescence) element. The organic EL element is a self-light-emitting element, unlike a liquid crystal element and the like. For that reason, the organic EL display apparatus does not include a light source (backlight) and thus has higher image visibility, lower power consumption, and faster response speed of elements than liquid crystal display apparatuses including light sources.

### SUMMARY

The organic EL display apparatus is provided with a plurality of gate drivers for scanning, which are disposed in a vertical direction for respective units of a predetermined number of rows each formed of a plurality of pixels. Each of the gate drivers controls light emission of the pixels in units of the predetermined number of rows that are assigned to the gate driver.

More specifically, each organic EL element that forms a pixel includes a drive transistor that controls the drive of light emission of the organic EL element, a pixel capacitance in which a video signal and a threshold potential are written, and a write transistor.

The gate driver controls the potential of write wiring and thus controls the write transistor to write a video signal in the pixel capacitance, the video signal being output from a signal output unit. The gate driver controls the potential of drive power supply wiring and thus provides a current corresponding to the pixel capacitance to the organic EL element, thus causing the organic EL to emit light at a luminance corresponding to the video signal.

When the potential of the drive power supply wiring is controlled for light emission of the organic EL element while the video signal is written in the pixel capacitances of a plurality of pixels that form each row, however, a voltage drop occurs which corresponds to a current flowing in the organic EL element when light is emitted. So, the voltage drop progresses toward the rows disposed downstream of the power supply. In particular, when a high-luminance range and a low-luminance range are included in units of a plurality of rows managed by one gate driver, a luminance gradient may appear due to a voltage drop in the low-luminance range. A wiring design in consideration of this luminance gradient has many limitations and may reduce the degree of freedom in wiring design.

In view of the circumstances as described above, it is desirable to suppress the occurrence of a luminance gradient by suppressing a voltage drop when a video signal is written, and to eliminate limitations on wiring design of the organic EL display apparatus due to the occurrence of the luminance gradient, thus enhancing the degree of freedom in wiring design.

According to an embodiment of the present disclosure, there is provided a display apparatus including light-emission units, write transistors, drive transistors, and a plurality of gate drivers. The light-emission units each form a pixel and each configured to emit light by a drive current. The write transistors are each configured to write a video signal of each pixel in each of pixel capacitances. The drive transistors are each configured to control the drive current of the light-emission unit by a voltage corresponding to the video signal written in the pixel capacitance. The plurality of gate drivers are configured to control write of the video signal in the pixel capacitances by the write transistors and control a drive voltage supplied to the drive transistors, the plurality of gate drivers being each configured to perform control such that the write transistors write the video signal in the pixel capacitances of all the pixels and then supply the drive voltage to the drive transistors.

The plurality of gate drivers may be each configured to perform control to sequentially apply a drive voltage to the drive transistors of the plurality of pixels in a scanning direction after the video signal is written in the pixel capacitances of all the pixels.

The plurality of gate drivers may be each configured to perform control to simultaneously apply a drive voltage to the drive transistors of the plurality of pixels after the video signal is written in the pixel capacitances of all the pixels.

The plurality of gate drivers may be each configured to control the drive voltage to be a midpoint potential until write of a threshold value in the pixel capacitances of all pixels is completed.

According to an embodiment of the present disclosure, there is provided a display method for a display apparatus, the display apparatus including light-emission units each forming a pixel and each configured to emit light by a drive current, write transistors each configured to write a video signal of each pixel in each of pixel capacitances, drive transistors each configured to control the drive current of the light-emission unit by a voltage corresponding to the video signal written in the pixel capacitance, and a plurality of gate drivers configured to control write of the video signal in the pixel capacitances by the write transistors and control a drive voltage supplied to the drive transistors, the display method including performing, by each of the gate drivers, control such that the write transistors write the video signal in the pixel capacitances of all the pixels and then supply the drive voltage to the drive transistors.

According to an embodiment of the present disclosure, the light-emission units each form a pixel and are each configured to emit light by a drive current, the write transistors are each configured to write a video signal of each pixel in each of pixel capacitances, the drive transistors are each configured to control the drive current of the light-emission unit by a voltage corresponding to the video signal written in the pixel capacitance, and the plurality of gate drivers are configured to control write of the video signal in the pixel capacitances by the write transistors and control a drive voltage supplied to the drive transistors, the plurality of gate drivers being each configured to perform control such that the write transistors write the video signal in the pixel capacitances of all the pixels and then supply the drive voltage to the drive transistors.

According to an embodiment of the present disclosure, it is possible to enhance the degree of freedom in wiring design of a gate driver.

These and other objects, features and advantages of the present disclosure will become more apparent in light of the following detailed description of best mode embodiments thereof, as illustrated in the accompanying drawings.

### BRIEF DESCRIPTION OF DRAWINGS

FIG. 1 is a diagram for describing a configuration of a display apparatus according to an embodiment of the present disclosure;

FIG. 2 is a diagram for describing a circuit configuration of each pixel in a display panel of the display apparatus of FIG. 1;

FIG. 3 is a timing chart for describing a general control method for the display apparatus of FIG. 1;

FIG. 4 is a diagram for describing a luminance gradient generated by the general control method;

FIG. 5 is a diagram for describing a voltage drop that causes a luminance gradient;

FIG. 6 is a diagram for describing an internal resistance and a parasitic capacitance that cause a voltage drop;

FIG. 7 is a diagram for describing states immediately after a video signal is written in a pixel capacitance of each pixel of the uppermost pixel row and immediately after a video signal is written in a pixel capacitance of each pixel of the lowermost pixel row, among pixel rows managed by one gate driver;

FIG. 8 is a diagram for describing a concept of a method of controlling a display apparatus according to the embodiment of the present disclosure;

FIG. 9 is a diagram for describing a specific example of the method of controlling a display apparatus according to the embodiment of the present disclosure;

FIG. 10 is a diagram for describing a voltage drop in the control method of FIG. 9;

FIG. 11 is a diagram for describing a state where a luminance gradient is suppressed by the control method according to the embodiment of the present disclosure;

FIG. 12 is a diagram showing a television set as a specific example of an electronic apparatus to which the embodiment of the present disclosure is applied; and

FIG. 13 is a diagram showing a smartphone as a specific example of the electronic apparatus to which the embodiment of the present disclosure is applied.

### DETAILED DESCRIPTION OF EMBODIMENTS

(Configuration Example of Display Apparatus)

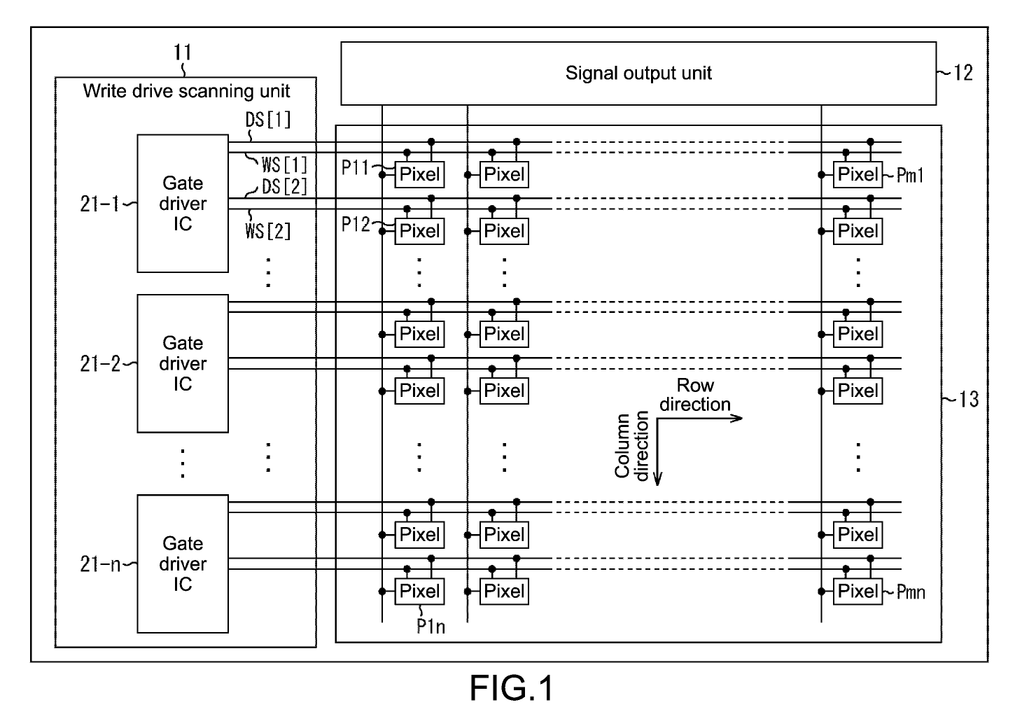

FIG. 1 is a block diagram showing a configuration example of a display apparatus including an organic EL (Electro Luminescence) element according to an embodiment of the present disclosure.

The display apparatus of FIG. 1 includes a write drive scanning unit 11, a signal output unit 12, and a display panel 13.

The write drive scanning unit 11 includes gate driver ICs (Integrated Circuits) 21-1 to 21-n. The write drive scanning unit 11 writes video signals, which are supplied from the signal output unit 12, in pixels P11 to Pmn on the display panel 13 and controls light emission.

In the following description, when the pixels P11 to Pmn are not particularly distinguished from one another and the gate driver ICs 21-1 to 21-n are not particularly distinguished from one another, the pixels and the gate driver ICs are simply referred to as a pixel Pmn and a gate driver IC 21. The same holds true for other configurations. Further, herein, for the pixel Pmn, m represents a position in a row direction and n represents a position in a column direction.

The gate driver IC 21 controls write of a video signal in each pixel Pmn of a predetermined number of pixel rows via a write wiring WS[n] and light emission of an organic EL element EL of each pixel Pmn via a drive wiring DS[n]. Additionally, the gate driver IC 21 controls write, drive, and scanning of pixels in pixel rows, among pixels in a plurality of rows controlled by each gate driver IC 21, sequentially in units of row from the upper row to the lower row in FIG. 1 or from the lower row to the upper row in FIG. 1 (in a scanning direction).

(Configuration Example of Pixel)

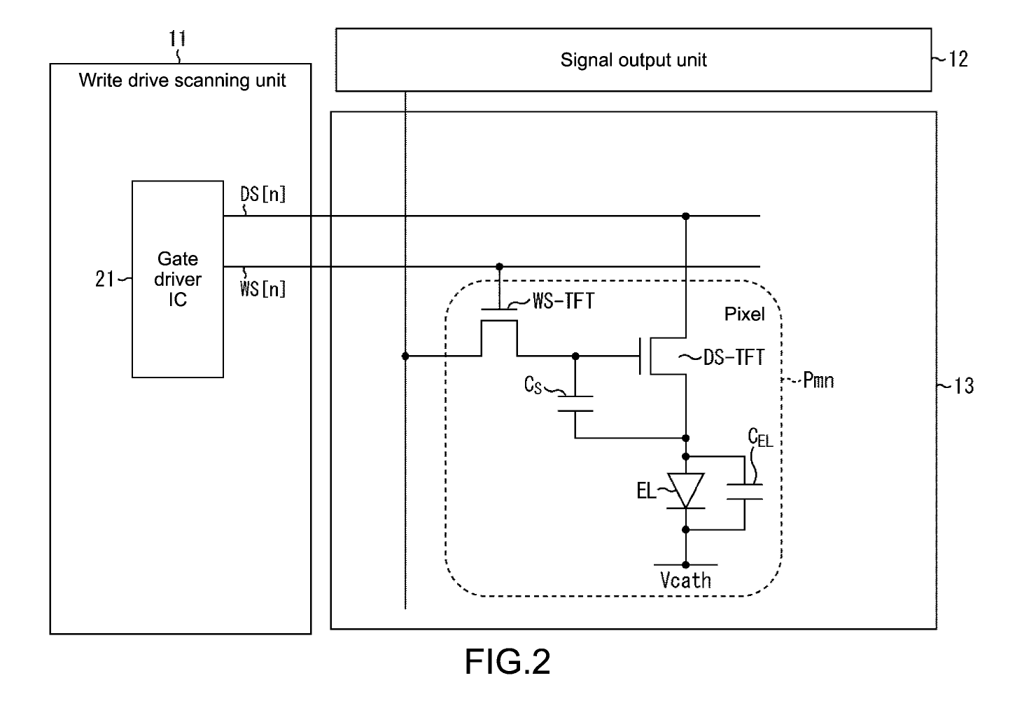

Next, a detailed configuration of each pixel will be described with reference to FIG. 2.

Each pixel Pmn includes a write transistor WS-TFT, a drive transistor DS-TFT, a pixel capacitance Cs, and an organic EL element EL. The write transistor WS-TFT and the drive transistor DS-TFT are each formed of a thin film transistor. It should be noted that a capacitance CEL of FIG. 1 is a parasitic capacitance of the organic EL element EL. The parasitic capacitance is generated by forming a circuit, but a substantial circuit thereof does not exist.

The write transistor WS-TFT has a gate and a drain. The gate is connected to the write wiring WS[n]. The drain receives an input of a voltage representing a video signal supplied from the signal output unit 12. Additionally, the write transistor WS-TFT has a source, which is connected to one end of the pixel capacitance Cs and to a gate of the drive transistor DS-TFT.

The drive transistor DS-TFT has a drain and a source. The drain is connected to the drive wiring DS[n]. The source is connected to the other end of the pixel capacitance Cs and to an anode of the organic EL element EL. The organic EL element EL has a cathode connected to a predetermined potential Vcath, i.e., ground potential.

In other words, the gate driver IC 21 controls on and off of the write transistor WS-TFT by using a write signal transmitted via the write wiring WS[n], and causes the write transistor WS-TFT to write the video signal in the pixel capacitance Cs. The video signal is output from the signal output unit 12. Additionally, the drive transistor DS-TFT is driven by the video signal written in the pixel capacitance Cs, and provides a current to the organic EL element EL. The current is determined by a potential supplied from the gate driver IC 21 to the drain of the drive transistor DS-TFT via the drive wiring DS[n] and by a gate-source voltage Vgs. The organic EL element EL emits light by a current that flows therein at that time.

(General Control Method)

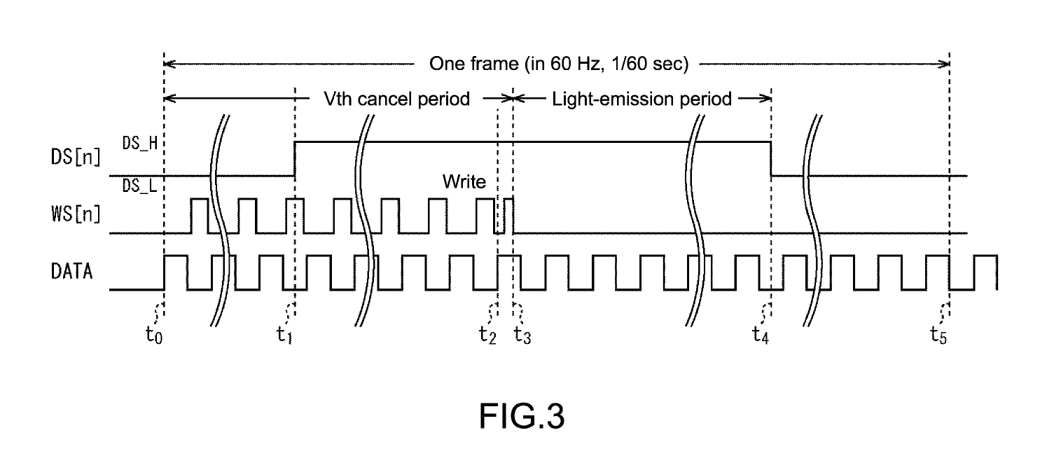

Next, a general control method for a display apparatus will be described with reference to FIG. 3. It should be noted that the upper row of FIG. 3 indicates an output waveform of a drive signal of the drive wiring DS[n]. Here, DS_H represents a high voltage of the drive signal and DS_L represents a low voltage of the drive signal. Additionally, the middle row of FIG. 3 represents an output waveform of a write signal output from the write wiring WS[n], and the lower row represents an output waveform of a video signal from the signal output unit 12.

In other words, the display apparatus has been controlled with a general gate driver in the past as described below. First, when processing corresponding to one frame in time t0 to t1 is started, initialization processing is executed. At that time, the drive signal is set to be low level DS_L, and the write signal and the video signal are sequentially output at a predetermined frequency. It should be noted that here, in the case of 60 Hz, one frame is 1/60 sec, for example.

At time t1, the drive signal is set to be high level DS_H, and a so-called threshold Vth cancel period is set in time t1 to t2, so that threshold Vth cancel processing is executed. Here, processing of adjusting the gate-source voltage of the drive transistor DS-TFT is performed, and a voltage corresponding to the threshold voltage is written in the pixel capacitance Cs. For details, see Japanese Patent Application Laid-open No. 2009-244665, for example.

In time t2 to t3, in which the threshold Vth cancel period is terminated, when the video signal is added to the threshold and thus the write of the video signal in the pixel capacitance Cs is completed, in time t3 to t4, the drive transistor DS-TFT is turned on and the organic EL element EL is provided with a current corresponding to the video signal written in the pixel capacitance Cs. Consequently, light is emitted at a luminance corresponding to a current value.

(Occurrence of Luminance gradient)

In the general control described above, immediately after a signal voltage corresponding to the video signal is written in the pixel capacitance Cs, the potential of the drive signal remains high level DS_H (ON-state), and thus light emission is immediately started.

When the number of rows (lines) that emit light increases, however, a current-dependent voltage drop occurs on the substrate of the drive wiring DS[n] or by wiring resistance or parasitic capacitance in each gate driver IC 21. As a result, in the display panel 13, periodic luminance gradients may occur at pitches of the gate driver ICs 21.

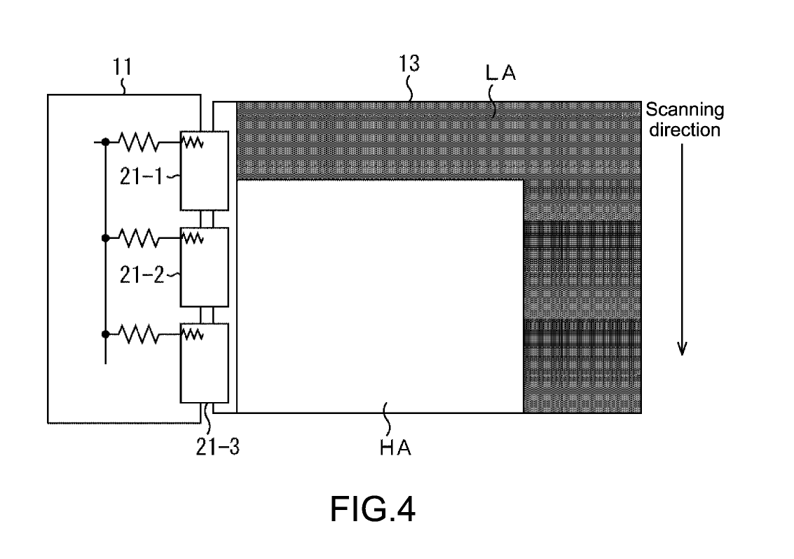

For example, as shown in FIG. 4, the write signals are scanned downward on the screen of the gate driver ICs 21. In the case where the pixel rows partially include a high-luminance display area HA and a low-luminance display area LA, the output voltage of the drive wiring DS of each gate driver IC 21 drops due to the influence of the wiring resistance when the amount of current increases.

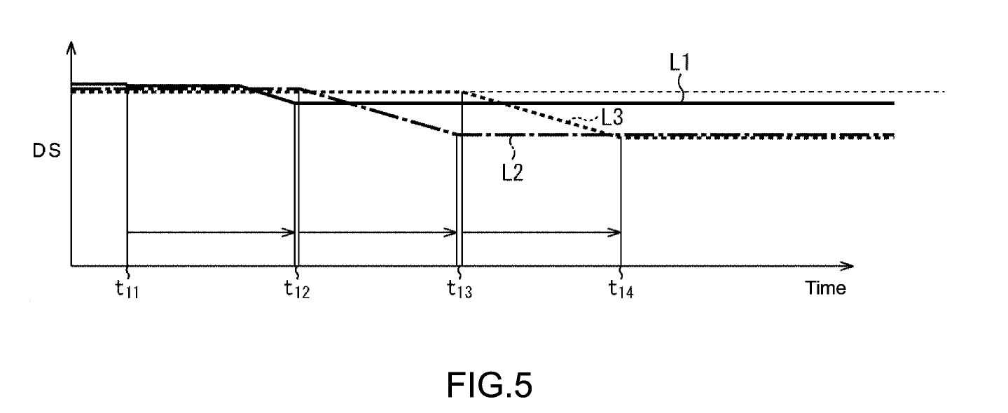

In such a manner, when the write and the light emission are repeated sequentially in units of row downward on the display panel 13, as shown in FIG. 5, a waveform L1 of a gate driver IC 21-1 is kept to have a normal voltage of the drive signal in a write period indicated by time t11 to t12. In time t12 to t13, however, as indicated by a waveform L2, a voltage of the drive signal gradually drops in a write period of a gate driver IC 21-2 along with the light emission of the gate driver IC 21-1. In the same manner, as indicated by a waveform L3 of a gate driver IC 21-3, in time t13 to t14, a voltage of the drive signal gradually drops in a write period of the gate driver IC 21-3 along with the light emission of the gate driver IC 21-2.

In other words, a current amount Ids of the drive signal involving the drive signal in each gate driver IC 21 increases with the light emission, resulting in the occurrence of a voltage drop during write. So, the voltage of the drive signal DS in the write is different between a write start row (upper row) and the last row (lower row) controlled in the gate driver IC 21.

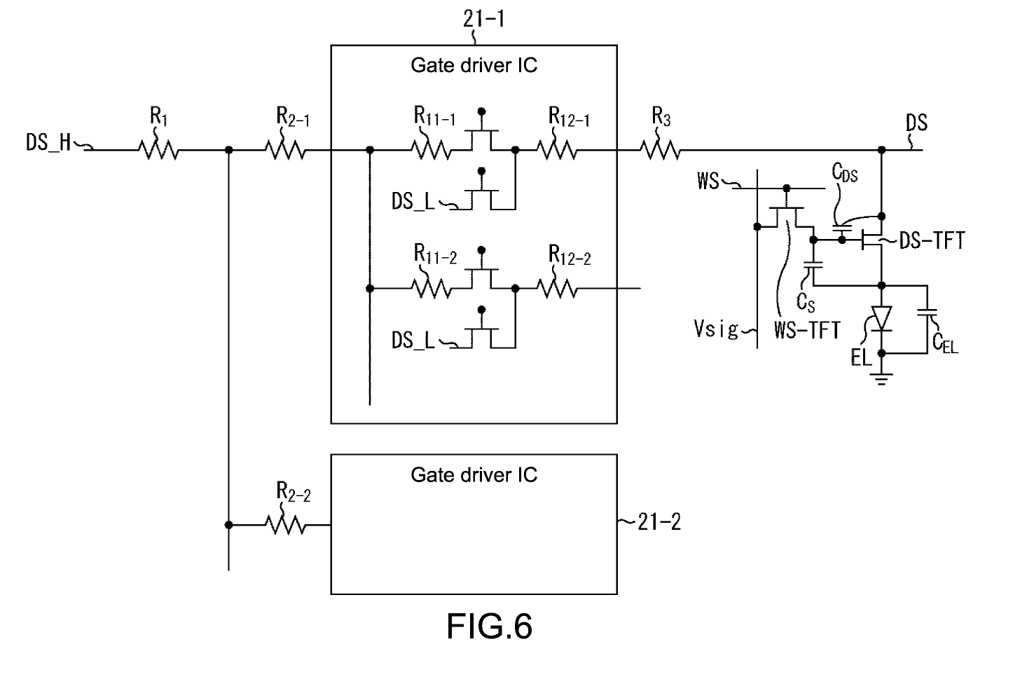

In other words, when the write in the first gate driver IC 21 is completed, the voltages of the drive signals DS become all the same, and at that timing, a write voltage of pixels in an upper row and a write voltage of pixels in a lower row in one gate driver IC 21 are the same. Subsequently, however, when the second gate driver IC 21 starts a write, the amount of voltage drop of the drive signal DS varies due to the influence of the current amount Ids that increases with light emission of pixels in a range in which the first gate driver IC 21 performs write. Thus, the variation amount of the voltage after write also varies by the parasitic capacitance CDS (FIG. 6) of the drive transistor DS-TFT. As a result, a luminance reduction (luminance gradient) like a gradation occurs downward from the upper portion to the lower portion of the rows controlled by the same gate driver IC 21.

In particular, as shown in FIG. 4, when the high-luminance display area HA and the low-luminance display area LA exist in the same row, a luminance change is difficult to recognize in the high-luminance display area HA, while even slight variations in write voltage are easy to recognize in the low-luminance display area LA.

So, if there is a low-luminance display area LA in the same row (lateral direction) as a high-luminance display area HA, as shown in FIG. 4, a luminance gradient occurs in the low-luminance display area LA in units of row managed by the gate driver IC 21.

(Internal Resistance)

Here, the internal wiring resistance and the parasitic capacitance in the gate driver IC 21 are as ones indicated by resistors R1 to R3, R11-1, R11-2, R12-1, and R12-2 and a parasitic capacitance CDS shown in FIG. 6, for example. Since the resistors R1 to R3, R11-1, R11-2, R12-1, and R12-2 and the parasitic capacitance CDS shown in FIG. 6 are the wiring resistance and the parasitic capacitance of wiring, a substantial circuit thereof does not exist.

In other words, the resistor R1 is a resistor formed of a drive power supply wiring DS (that supplies a high voltage DS_H) and a gate substrate or a printed-circuit board, and the like. The resistors R2-1 and R2-2 are wiring resistors disposed in a stage before an ACF (Anisotropic Conductive Film) crimp resistor and the gate driver IC 21. The resistors R11-1, R11-2, R12-1, and R12-2 are each a wiring resistance disposed before and after a branch position between a high voltage DS_H and a low voltage DS_L in each pixel. Additionally, the resistor R3 is a wiring resistance between the gate driver IC 21 and a pixel. The parasitic capacitance CDS is a parasitic capacitance between the source and gate of the drive transistor DS-TFT.

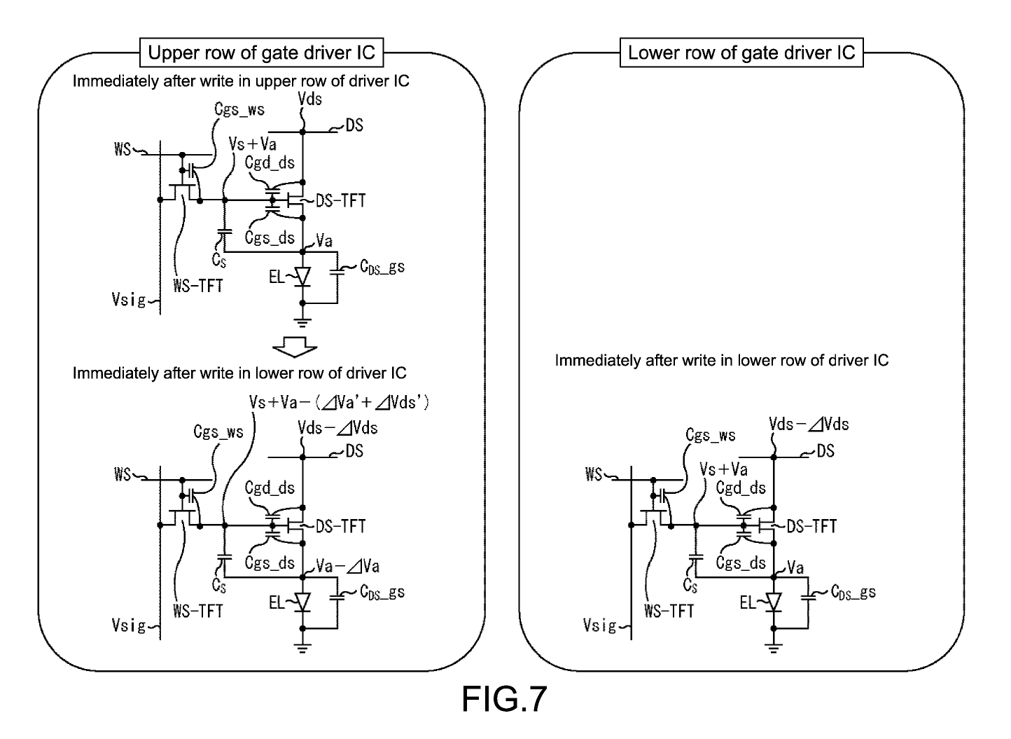

Due to those wiring resistances and parasitic capacitance, for example, a voltage drop as shown in FIG. 7 occurs. It should be noted that the upper-left part of FIG. 7 shows a state of each pixel of the uppermost row, immediately after write is performed in each pixel of the uppermost row managed by the gate driver IC 21, and the lower-left part of FIG. 7 shows a state of each pixel of the uppermost row, immediately after write is performed in each pixel of the lowermost row managed by the gate driver IC 21. Further, the lower-right part of FIG. 7 shows a state of each pixel of the lowermost row, immediately after write is performed in each pixel of the lowermost row managed by the gate driver IC 21. Here, no signals are supplied to the pixels of the lowermost row immediately after write is performed in the pixels of the uppermost row, and thus the pixels of the lowermost row are not displayed.

Furthermore, in each pixel in the upper pixel row among the pixel rows controlled by the gate driver IC 21, it is assumed that a potential of the drive wiring DS immediately after the write in the pixel capacitance Cs is performed is a potential Vds, and the current amount of the drive wiring DS is a current amount Ids. Moreover, an anode potential of the organic EL element EL at that time is assumed as a potential Va and a video signal is also represented by Vsig.

So, in this case, assuming that the gate-source voltage of the drive transistor DS-TFT is assumed as a voltage Vs, a gate potential of the drive transistor DS-TFT that is to be a write potential of the pixel capacitance Cs is assumed as a potential (Vs+Va).

From this state, immediately after the write in the pixel capacitance Cs is completed for the uppermost pixel row among the pixel rows managed by one gate driver IC 21, a write operation for a lower pixel row is sequentially performed. As shown in the lower-left part of FIG. 7, with the increase of the current amount Ids, the potential of the drive wiring DS drops by a potential ΔVds from the potential Vds, to be changed to a potential (Vds-ΔVds).

At that time, a voltage drop (ΔVa′+ΔVds′) occurs due to the parasitic capacitance Cgd_ds of the drive transistor DS-TFT, and the current Ids flowing through the source and drain of the drive transistor DS-TFT is reduced.

Here, ΔVds′=ΔVds*Cgd_ds/Call, where Call represents the sum of a gate-source parasitic capacitance Cgs_ws of the write transistor WS-TFT, the pixel capacitance Cs, the gate-drain parasitic capacitance Cgd_ds of the drive transistor DS-TFT, and a gate-source parasitic capacitance Cgs_ds of the drive transistor DS-TFT. Further, ΔVa′=ΔVa*Cgd_ds/Call.

On the other hand, of the pixel rows managed by one gate driver IC 21, the write signal in a lower pixel row is not generated at a time at which the write in an upper pixel row is completed, and thus there is no operating state to be compared. When the upper pixel row of the display panel 13 sequentially emits light, the write signal is written as in the case of the upper-left part of FIG. 7, as shown in the lower-right part of FIG. 7.

So, the write signal is recorded sequentially from the upper pixel row to the lower pixel row as described above, and thus the voltage drop progresses more as the processing proceeds toward the lower pixel row. Conversely, the voltage drop appears significantly in the upper pixel row and weakens toward the lower pixel row. As a result, as shown in the low-luminance display area LA of FIG. 4, a luminance gradient is generated periodically in units of pixel row controlled by one gate driver IC 21.

(Concept of Control Method According to Embodiment of Present Disclosure)

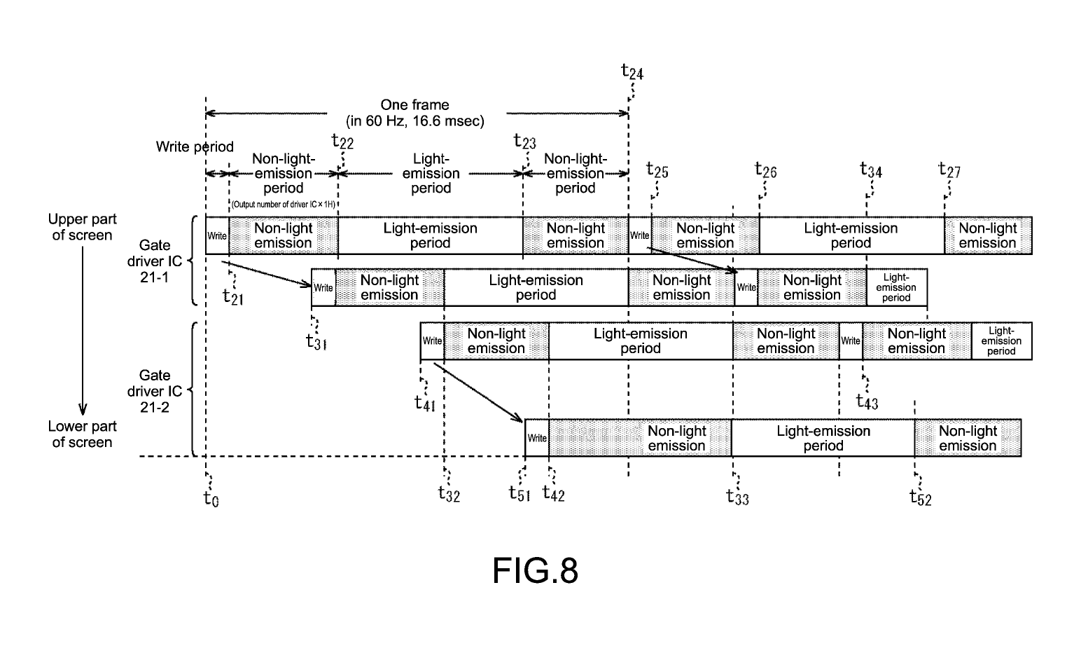

As described above, it is necessary to suppress a voltage drop, which occurs because the write and the light emission are repeated sequentially from the upper pixel row. So, as shown in FIG. 8, a standby state is provided until the write of a video signal is completed for all pixels in units of gate driver IC 21, and light emission is allowed after the write is completed for all pixels.

It should be noted that in FIG. 8, write processing is sequentially executed in every pixel rows in units of gate driver IC 21 from the upper part of the screen, and when the write is completed for all pixels, light is sequentially emitted from the upper pixel row.

More specifically, the upper row of FIG. 8 shows that write processing is executed for a head pixel row of the gate driver IC 21-1 in time t0 to t21, and in time t21 to t22, a non-light-emission period, that is, the standby state is provided. In this time t21 to t22, the write processing is sequentially executed from the upper pixel row, though not shown in the figure. In time t31 to t22, write processing for the lowermost pixel row is executed.

In time t22 to t23, the uppermost pixel row is in the light-emission period, and light emission processing is sequentially repeated from the upper pixel row, and in time t32 to t24, light emission processing of each pixel of the lowermost pixel row is executed. Hereinafter, the similar processing is repeated in units of gate driver IC 21.

Further, as shown in FIG. 8, in the gate driver IC 21-2, after the write processing on the uppermost pixel row is executed in time t41 to t32, though not shown in the figure, write processing is executed sequentially from the upper pixel row. When the write processing of the lowermost pixel row in time t51 to t42 is completed, light emission processing is executed sequentially from the upper pixel row as shown in time t42 to t33.

As described above, the write processing and the light emission processing are sequentially executed from above also in units of gate driver IC 21. Thus, a current does not flow all at once but is dispersed. Thus, it is possible to suppress the occurrence of the luminance gradient due to the voltage drop caused by a current concentration. Since the occurrence of the luminance gradient results from the wiring resistance or parasitic capacitance in one gate driver IC 21, even when all of the gate driver ICs 21 are designed to be driven at the same time, it is possible to suppress the occurrence of the luminance gradient more than by the general control method in related art.

It should be noted that the interval in which all the pixels emit light is a period corresponding to one frame, and in the case of 60 Hz, for example, the interval is 16.6 msec.

(Specific Control Method According to Embodiment of Present Disclosure)

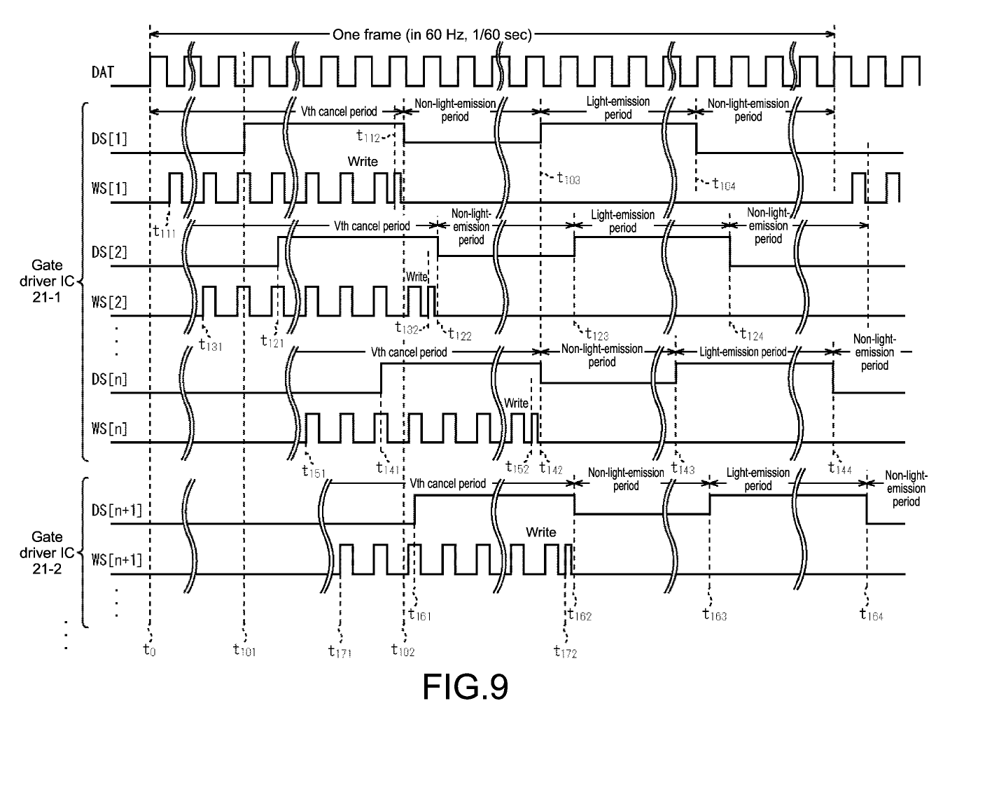

Next, a specific control method according to an embodiment of the present disclosure will be described with reference to a timing chart of FIG. 9. It should be noted that FIG. 9 shows a video signal DAT in the uppermost row, and below the video signal DAT, output waveforms of a drive signal of the drive wiring DS[x] and of a write signal of the write wiring WS[x] (x=1, 2, . . . , and n) of respective rows of the gate driver ICs 21-1, 21-2, . . . sequentially from above.

In other words, at time to, processing of the first frame is started for the uppermost pixel row in the gate driver IC 21-1 that controls a plurality of pixel rows in the vicinity of the uppermost pixel row of the display panel 13.

At time t111, a write signal is output from a write wiring WS[1] so as to prepare threshold Vth cancelling.

At time t101, a drive signal of a drive wiring DS[1] is controlled from a low level DS_L to a high level DS_H and a threshold Vth cancel period is set. The threshold Vth cancel processing of the drive transistor DS-TFT is started, and a threshold is written in the pixel capacitance Cs.

In time t112 to t102, the write transistor WS-TFT executes write processing of a video signal in the pixel capacitance Cs, and at that timing, the drive signal of the drive wiring DS[1] is set to have a midpoint potential M (DS_L<M<DS_H). By this processing, at time t102, the threshold Vth cancel processing is terminated and a non-light-emission period is set.

In contrast, for the second top pixel row, at time t131 at which a predetermined period of time elapses from time t111, a write signal is output from a write wiring WS[2] to the second pixel row in the gate driver IC 21-1 of the display panel 13 so as to prepare threshold Vth cancelling.

At time t121 at which a predetermined period of time elapses from time t101, a drive signal of a drive wiring DS[2] is controlled from a low level DS_L to a high level DS_H and a threshold Vth cancel period is set. The threshold Vth cancel processing of the drive transistor DS-TFT is started.

In time t132 to t122, the write transistor WS-TFT executes write processing of a video signal in the pixel capacitance Cs, and at that timing, the drive signal of the drive wiring DS[2] is set to have a midpoint potential M (DS_L<M<DS_H). By this processing, at time t122, the threshold Vth cancel processing is terminated and a non-light-emission period is set.

Hereinafter, in the same manner, the threshold Vth cancel period, the write processing, and the non-light-emission period are repeated sequentially in every pixel rows from above at predetermined time intervals.

At time t151 at which a predetermined time interval elapses from a timing at which a write signal is output from an write wiring WS[n−1] in an (n−1)-th row (not shown) located immediately before the lowermost row, a write signal is output from a write wiring WS[n] to an n-th pixel row, which is the lowermost pixel row in the gate driver IC 21-1 of the display panel 13 so as to prepare threshold Vth cancelling.

At time t141 at which a predetermined period of time elapses from a timing at which threshold Vth cancel processing of an (n−1)-th drive transistor DS-TFT (not shown) is started, a drive signal of a drive wiring DS[n] is controlled from a low level DS_L to a high level DS_H and a threshold Vth cancel period is set. The threshold Vth cancel processing of the drive transistor DS-TFT is started.

In time t152 to t142, the write transistor WS-TFT executes write processing of a video signal in the pixel capacitance Cs, and at that timing, the drive signal of the drive wiring DS[n] is set to have a midpoint potential M (DS_L<M<DS_H). By this processing, at time t142, the threshold Vth cancel processing is terminated and a non-light-emission period is set.

In other words, through the above processing, the threshold Vth cancel processing is sequentially executed in every pixel rows from above and the write in the pixel capacitance Cs is executed at predetermined time intervals. Thus, the threshold Vth cancel processing and the write in the pixel capacitance Cs are completed for all pixel rows.

Additionally, at time t103 (=t142) at which the threshold Vth cancel processing for all pixel rows is executed and the write in the pixel capacitance Cs is completed, in the uppermost pixel row, the drive signal of the drive wiring DS[1] is controlled from the midpoint potential M to the high level DS_H. By the processing, for the uppermost pixel row, a current flows in the organic EL element EL of each pixel, and thus light emission is started.

At time t104 at which a predetermined period of time elapses from time t103, for the uppermost pixel row, the drive signal of the drive wiring DS[1] is controlled from the high level DS_H to the low level DS_L. By the processing, a current flow to the organic EL element EL of each pixel of the uppermost pixel row is stopped and a non-light-emission period is set.

At time t123 at which a predetermined period of time elapses from time t103, for the second top pixel row, the drive signal of the drive wiring DS[2] is controlled from the midpoint potential M to the high level DS_H. By the processing, a current flows in the organic EL element EL of each pixel of the second top pixel row, and thus light emission is started.

At time t124 at which a predetermined period of time elapses from time t123, for the second top pixel row, the drive signal of the drive wiring DS[2] is controlled from the high level DS_H to the low level DS_L. By the processing, a current flow to the organic EL element EL of each pixel of the second top pixel row is stopped and a non-light-emission period is set.

Hereinafter, in the same manner, the drive signal is sequentially controlled from the midpoint potential M to the high level DS_H in every pixel rows from above at the predetermined intervals. At time t143 at which a predetermined period of time elapses from a time at which a drive signal of a drive wiring DS[n−1] in the (n−1)-th row located immediately before the lowermost row is controlled from the midpoint potential M to the high level DS_H, for the lowermost n-th pixel row, the drive signal of the drive wiring DS[n] is controlled from the midpoint potential M to the high level DS_H. By the processing, a current flows in the organic EL element EL and light emission is started.

At time t144 at which a predetermined period of time elapses from time t143, for the lowermost n-th pixel row, the drive signal of the drive wiring DS[n] is controlled from the high level DS_H to the low level DS_L. By the processing, a current flow to the organic EL element EL of each pixel in the lowermost pixel row is stopped and a non-light-emission period is set.

Next, for an (n+1)-th pixel row, which is the uppermost pixel row of the gate driver IC 21-2 below the gate driver IC 21-1, at time t171 at which a predetermined period of time elapses from time t151 in the n-th pixel row, i.e., the lowermost row of the gate driver IC 21-1, a write signal is output from the write wiring WS[n+1] so as to prepare threshold Vth cancelling.

At time t161 at which a predetermined period of time elapses from time t151, a drive signal of a drive wiring DS[n+1] is controlled from the low level DS_L to the high level DS_H and a threshold Vth cancel period is set. The threshold Vth cancel processing of the drive transistor DS-TFT is started.

In time t172 to t162, the write transistor WS-TFT executes write processing of a video signal in the pixel capacitance Cs, and at that timing, the drive signal of the drive wiring DS[n+1] is set to have a midpoint potential M (DS_L<M<DS_H). By this processing, at time t162, the threshold Vth cancel processing is terminated and a non-light-emission period is set.

Hereinafter, for the pixel rows controlled by the gate driver IC 21-2 as well, in the same manner, the threshold Vth cancel processing and the write processing are sequentially executed from above at the predetermined intervals. At time t163 at which the processing of the pixel rows is completed, the drive signal of the drive wiring DS[n+1] is controlled from the midpoint potential M to the high level DS_H. By the processing, a current flows in the organic EL element EL and light emission is started.

At time t164 at which a predetermined period of time elapses from time t163, for the (n+1)-th pixel row, which is the uppermost pixel row of the gate driver IC 21-2, the drive signal of the drive wiring DS[n+1] is controlled from the high level DS_H to the low level DS_L. By the processing, a current flow to the organic EL element EL of each pixel is stopped and a non-light-emission period is set. Hereinafter, the pixel rows sequentially enter a light-emission state at predetermined time intervals.

In other words, the threshold Vth cancel processing and the write processing are sequentially executed for every pixel rows controlled by one gate driver IC 21 from above. From a timing at which the processing are completed for all the pixel rows, light is sequentially emitted from every pixel rows from above at predetermined time intervals.

Through the above processing, the control method according to an embodiment of the present disclosure is applied, and the threshold Vth cancel processing and the write processing are executed with the organic EL elements EL of all pixels corresponding to one gate driver IC 21 being in the non-light-emission state. After the threshold Vth cancel processing and the write processing are completed for all the pixels, the pixel rows sequentially emit light one by one from above.

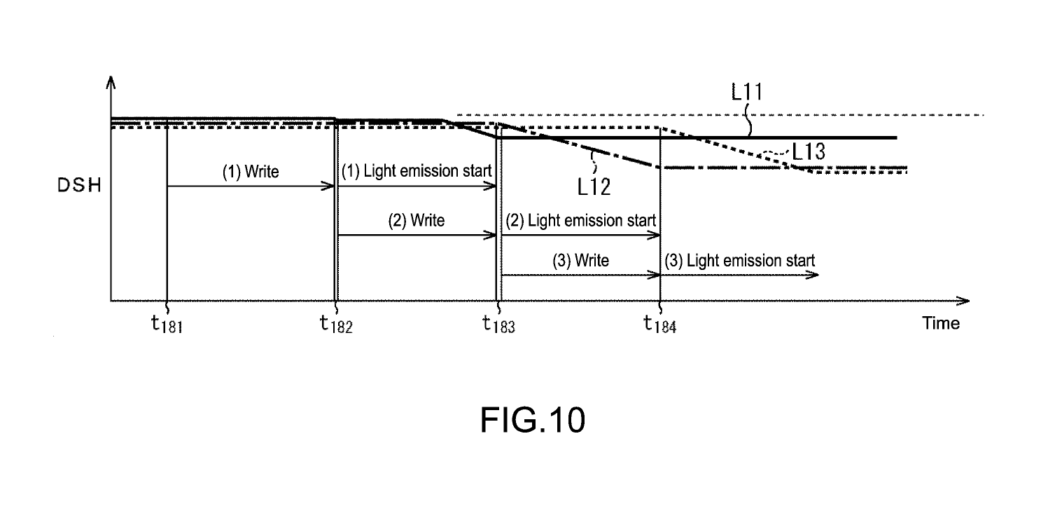

For that reason, during execution of the threshold Vth cancel processing and the write processing for all the pixels of one gate driver IC 21, as shown in FIG. 10, a state is provided in which a voltage drop does not occur. So, there is no case where the luminance gradually changes toward the lower pixel rows.

It should be noted that waveforms L11 to L13 of FIG. 10 indicate changes in a time direction in high voltage DS_H of the drive wiring DS in the gate driver ICs 21-1 to 21-3, respectively. Here, as indicated by the waveform L11, in time t181 to t182, the write processing of each pixel row related to the gate driver IC 21-1 is executed. Additionally, as indicated by the waveforms L11 and L12, in time t182 to t183, the light emission processing of each pixel row related to the gate driver IC 21-1 and the write processing of each pixel row related to the gate driver IC 21-2 are executed. Furthermore, as indicated by the waveforms L12 and L13, in time t183 to t184, the light emission processing of each pixel row related to the gate driver IC 21-2 and the write processing of each pixel row related to the gate driver IC 21-3 are executed. Moreover, as indicated by the waveform L13, after time t184, the light emission processing of each pixel row related to the gate driver IC 21-3 is executed.

In any case, during execution of the write processing in units of gate driver IC 21, a voltage drop of the high voltage DS_H of the drive wiring DS does not occur. It should be noted that in FIG. 10, the write processing is indicated by “write”, and the light emission processing is indicated by “light emission start”, to which encircled numbers corresponding to the gate driver ICs 21-1 to 21-3 are assigned.

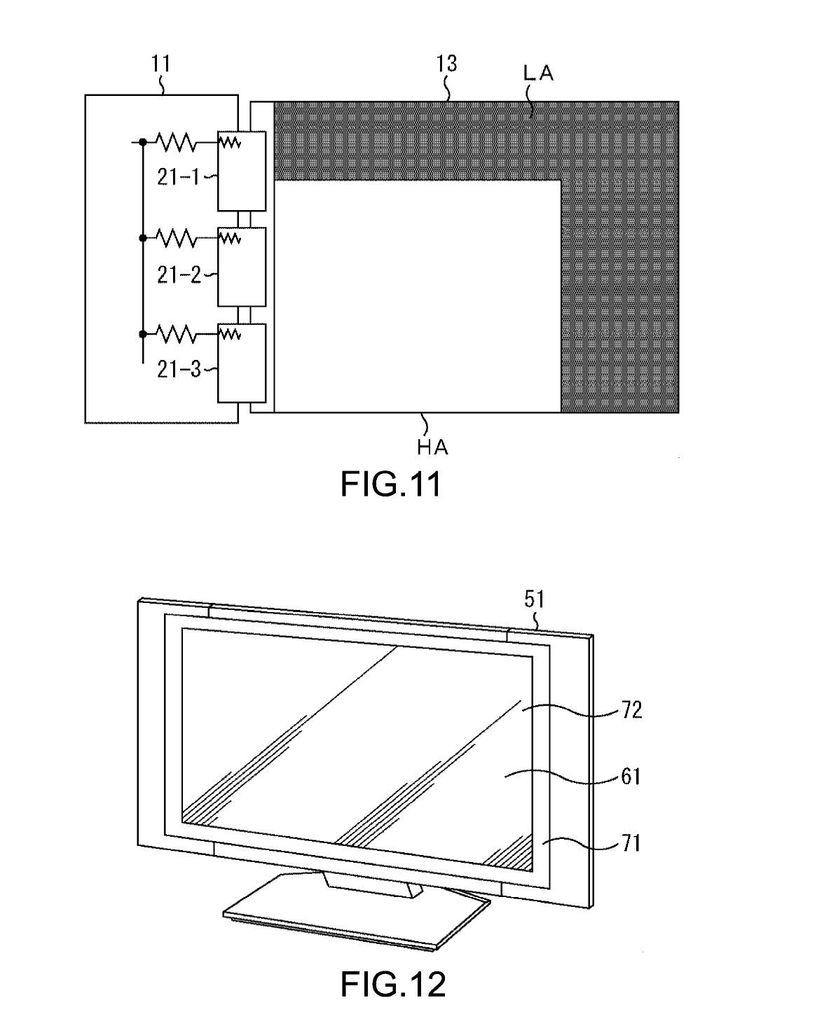

As a result, as shown in FIG. 11, even when the high-luminance display area HA and the low-luminance display area LA are included in the same pixel row of the display panel 13, the occurrence of the luminance gradient in units of the pixel rows managed by the gate driver IC 21 in the low-luminance display area LA can be suppressed.

After the write for all pixels of the gate driver IC 21 is completed, all of the pixel rows may be caused to emit light at the same time. Also in the light emission, however, a light emission timing is made different between rows sequentially from above in every predetermined time intervals, and thus a large current due to the simultaneous light emission can be favorably prevented from flowing, and the effects of suppressing the occurrence of the luminance gradient can be favorably obtained with a high accuracy.

Additionally, as described above, after the write is completed for all pixel rows and light is sequentially emitted in units of pixel row in a gate driver IC 21, the threshold Vth cancel processing and the write processing are executed also for the pixel rows controlled by different gate driver ICs 21 at the predetermined time intervals. During the threshold Vth cancel processing and the write processing in units of gate driver IC 21, however, light may not be emitted and, for example, the threshold Vth cancel processing and the write processing may be executed for all the gate driver ICs 21 at the same time at the predetermined time intervals. Also in this case, when the threshold Vth cancel processing, the write processing, and the light emission processing are executed for all the pixel rows with delay of predetermined time intervals, a time in which a current flows at a burst can be shortened. Thus, the effects of suppressing the occurrence of the luminance gradient can be expected with higher accuracy.

As a result, since limitations on a wiring design in which the occurrence of the luminance gradient is taken into consideration can be eliminated, the degree of freedom in wiring design can be enhanced.

It should be noted that the embodiment of the present disclosure is not limited to the embodiment described above and may be variously modified without departing from the gist of the present disclosure.

(Specific Examples of Electronic Apparatus to which Embodiment of Present Disclosure is Applied)

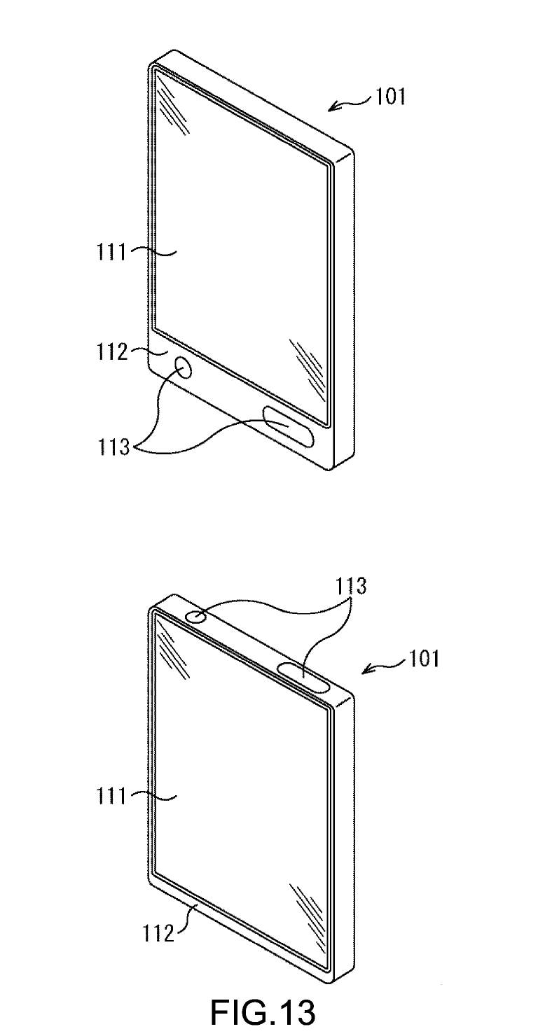

Next, specific examples of an electronic apparatus to which an embodiment of the present disclosure is applied will be described with reference to FIGS. 12 and 13.

FIG. 12 is a perspective view showing an outer appearance of a television set as an example of an electronic apparatus. A television set 51 according to this application example includes a video-displaying screen 61 including a front panel 71, a filter glass 72, and the like. The television set 51 is manufactured using the video-displaying screen 61, that is, the organic EL display apparatus according to an embodiment of the present disclosure. The application of the present disclosure can lead to the suppression of the occurrence of the luminance gradient of the video-displaying screen 61 and contribute to enhancement of the degree of freedom in wiring design in a circumferential area of the display portion of the television set 51.

FIG. 13 shows an outer appearance of a smartphone as an example of the electronic apparatus. This smartphone 101 includes, for example, a display 111, a casing 112, and an operating unit 113. The operating unit 113 may be provided to the front surface of the casing 112 as shown in the upper part of FIG. 13 or may be provided to the top surface of the casing 112 as shown in the lower part of FIG. 13. When the organic EL display apparatus according to an embodiment of the present disclosure is used as the display 111 of the smartphone 101, limitations on wiring design can be eliminated, and thus a circumferential area of the display portion can be reduced, thus contributing to the downsizing of the smartphone 101 or to the enhancement of the degree of freedom in design of the main body of the smartphone 101.

As described above, the organic EL display apparatus according to an embodiment of the present disclosure can be applied to a display (display apparatus) of an electronic apparatus in any other field, in which a video signal input to the electronic apparatus or a video signal generated in the electronic apparatus is displayed as images or videos. FIG. 12 shows a television set and FIG. 13 shows a smartphone as examples, but the organic EL display apparatus according to an embodiment of the present disclosure should not be limited thereto and can be applied to displays of various electronic apparatuses, for example, digital cameras, laptop personal computers, mobile terminals, and video cameras.

It should be noted that the present disclosure can have the following configurations.

(1) A display apparatus, including:

light-emission units each forming a pixel and each configured to emit light by a drive current;

write transistors each configured to write a video signal of each pixel in each of pixel capacitances;

drive transistors each configured to control the drive current of the light-emission unit by a voltage corresponding to the video signal written in the pixel capacitance; and

a plurality of gate drivers configured to control write of the video signal in the pixel capacitances by the write transistors and control a drive voltage supplied to the drive transistors, the plurality of gate drivers being each configured to perform control such that the write transistors write the video signal in the pixel capacitances of all the pixels and then supply the drive voltage to the drive transistors.

(2) The display apparatus according to (1), in which

the plurality of gate drivers are each configured to perform control to sequentially apply a drive voltage to the drive transistors of the plurality of pixels in a scanning direction after the video signal is written in the pixel capacitances of all the pixels.

(3) The display apparatus according to (1), in which

the plurality of gate drivers are each configured to perform control to simultaneously apply a drive voltage to the drive transistors of the plurality of pixels after the video signal is written in the pixel capacitances of all the pixels.

(4) The display apparatus according to any one of (1) to (3), in which

the plurality of gate drivers are each configured to control the drive voltage to be a midpoint potential until write of a threshold value in the pixel capacitances of all pixels is completed.

(5) A display method for a display apparatus, the display apparatus including

light-emission units each forming a pixel and each configured to emit light by a drive current,

write transistors each configured to write a video signal of each pixel in each of pixel capacitances,

drive transistors each configured to control the drive current of the light-emission unit by a voltage corresponding to the video signal written in the pixel capacitance, and

a plurality of gate drivers configured to control write of the video signal in the pixel capacitances by the write transistors and control a drive voltage supplied to the drive transistors,

the display method including performing, by each of the gate drivers, control such that the write transistors write the video signal in the pixel capacitances of all the pixels and then supply the drive voltage to the drive transistors.

It should be understood by those skilled in the art that various modifications, combinations, sub-combinations and alterations may occur depending on design requirements and other factors insofar as they are within the scope of the appended claims or the equivalents thereof.

What is claimed is:

1. A display apparatus, comprising:
light-emission units each forming a pixel and each configured to emit light by a drive current;
write transistors each configured to write a video signal of each pixel in each of pixel capacitances;
drive transistors each configured to control the drive current of the light-emission unit by a voltage corresponding to the video signal written in the pixel capacitance; and
a plurality of gate drivers configured to control write of the video signal in the pixel capacitances by the write transistors and control a drive voltage supplied to the drive transistors, the plurality of gate drivers being each configured to perform control such that the write transistors write the video signal in the pixel capacitances of all the pixels and then supply the drive voltage to the drive transistors.

2. The display apparatus according to claim 1, wherein
the plurality of gate drivers are each configured to perform control to sequentially apply a drive voltage to the drive transistors of the plurality of pixels in a scanning direction after the video signal is written in the pixel capacitances of all the pixels.

3. The display apparatus according to claim 1, wherein
the plurality of gate drivers are each configured to perform control to simultaneously apply a drive voltage to the drive transistors of the plurality of pixels after the video signal is written in the pixel capacitances of all the pixels.

4. The display apparatus according to claim 1, wherein
the plurality of gate drivers are each configured to control the drive voltage to be a midpoint potential until write of a threshold value in the pixel capacitances of all pixels is completed.

5. A display method for a display apparatus, the display apparatus including
light-emission units each forming a pixel and each configured to emit light by a drive current,
write transistors each configured to write a video signal of each pixel in each of pixel capacitances,
drive transistors each configured to control the drive current of the light-emission unit by a voltage corresponding to the video signal written in the pixel capacitance, and
a plurality of gate drivers configured to control write of the video signal in the pixel capacitances by the write transistors and control a drive voltage supplied to the drive transistors,
the display method comprising performing, by each of the gate drivers, control such that the write transistors write the video signal in the pixel capacitances of all the pixels and then supply the drive voltage to the drive transistors.
